(19) United States
(12) Patent Application Publication
(10) Pub. No.: US 2016/0314474 A1
(43) Pub. Date: Oct. 27, 2016

(54) GEO-ANALYTIC SYSTEM AND METHOD FOR AUTHENTICATION OF GOODS

(71) Applicant: 9210482 Canada Corporation, Markham (CA)

(72) Inventors: EITAN SCHIBI, Toronto (CA); MELISSA ROSEN, Toronto (CA)

(21) Appl. No.: 14/695,888

(22) Filed: Apr. 24, 2015

(51) Int. Cl. G06Q 30/00; G06K 7/14; G06K 7/10

(52) U.S. Cl. CPC G06Q 30/018; G06K 7/10861; G06K 7/1417; G06K 7/10881; G06K 7/10386

(57) ABSTRACT

Disclosed are geo-analytical systems and methods for providing assessments of whether articles purporting to be a genuine specimen authorized by a source are indeed genuine. Genuine specimens of the product from the source have affixed thereto an identifier unique amongst genuine such products and readable by a mobile device. A mobile device may collect the identifier and send it to a server along with the location where it was collected. The server maintains a history of collections of the identifier. The history may include information such as a date and/or time of each collection. The collection history is analyzed to produce an assessment of the likelihood the article is a genuine specimen by estimating the likelihood the history corresponds to a genuine article. The assessment is sent to the mobile device for presentation to a user.

### TECHNICAL FIELD

This relates to systems and methods for authentication of goods and other articles, and more particularly to geo-analytic systems and methods for electronically providing automated assessments of the likelihood that goods and other articles are authentic wares from a source by way of a computer network.

### BACKGROUND

Counterfeiting is the practice of manufacturing products, often of inferior quality, and selling them under a brand name without the brand owner's authorization.

Consumers who unwittingly purchase a counterfeit product are faced with a potential waste of their money spent on the inferior goods or the disappointment of learning that a fashionable item is only a “cheap knock-off.”

Common approaches taken by brands to prevent counterfeits, including the hiring of private investigators to look for counterfeit product for sale and engaging assistance from customs and police to enforce against suspected counterfeits, can be labor intensive.

Consumers, on the other hand, are provided limited tools to avoid counterfeits. In some cases consumers are provided with guidance by manufacturers on how to “spot a fake” but such guidance is typically specific to a given product. In other cases consumers are “armed” by police and other authorities with little more than aphorisms such as “if it seems too good to be true, it probably is”. Generally assessment of particular goods requires specialized knowledge of a particular product. As such, consumers have no easy way of assessing the genuineness of wares at point-of-sale.

Other goods are provided with holograph or other special tags, that may or may not be visible. Yet other goods include certificates of authenticity.

These tools however do not provide real-time authentication. Such tools are also generally unsatisfactory to consumers and to manufacturers.

### SUMMARY

In one aspect, there is provided a method of providing a potential consumer with an assessment of whether an article is genuine, reliant on a server in communication with a mobile customer device. The article purports to be a genuine specimen of a product authorized by a source. Genuine specimens of the product from the source have a unique identifier affixed to them—such as a unique tag readable by the mobile device. The method includes receiving, at the server from the mobile device, a request initiated by the potential consumer. The request includes a notification of a reading, by the mobile device, of the identifier affixed to the article and an indication corresponding to the location of the mobile device at the time of the collection. By analyzing the indicator and the current location of the tag, the server can assess whether the travels of the indicator are credible for a genuine specimen of the article.

In this way, a geo-analytic assessment may be made of the authenticity of the article, by assessing whether measured travels of an associated tag are consistent with the travels of an authentic article.

In another aspect, there is provided a computer system for providing a potential consumer of an article with an assessment of whether the article is genuine, the article purporting to be a genuine specimen of a product authorized by a source, wherein genuine specimens of the product from the source have affixed thereto an identifier unique amongst the genuine specimens, the system comprising: at least one processor; a network adapter in communication with the at least one processor; a memory in communication with the at least one processor, the memory storing instructions that, when executed by the at least one processor, cause the computer system to: receive, from a mobile device using the network adapter, a request initiated by the potential consumer, the request comprising a notification of a reading, by the mobile device, of an identifier affixed to the article and an indication corresponding to the location of the mobile device at the time of the collection; append, to a collection history associated with the identifier, an entry comprising the indication corresponding to the location of the mobile device at the time of the collection and an indication corresponding to the time of the collection, the collection history comprising a plurality of entries, each entry corresponding to a collection of the identifier by a mobile device; analyze the collection history using one or more analytical techniques resulting in an assessment of whether the article is likely a genuine specimen of the product authorized by the source, the assessment comprising estimating a likelihood that the collection history corresponds to movement of an genuine specimen of the product, and; send, to the mobile device using the network adapter, a response indicating the assessment.

### BRIEF DESCRIPTION OF THE DRAWINGS

Embodiments are described in detail below, with reference to the following drawings.

FIG. 1 is a diagram illustrating the operating environment of an example embodiment;

FIG. 2 is a high-level block diagram of a computing device, exemplary of an embodiment;

FIG. 3 illustrates the software organization of the computer of FIG. 2;

FIG. 4 is a flow chart depicting example blocks performed by the assessment server software of FIG. 3;

FIG. 5 illustrates a representation of a collection history, exemplary of an embodiment;

FIG. 6 is a high-level block diagram of a client device, exemplary of an embodiment;

FIG. 7 illustrates the software organization of the client device of FIG. 6;

FIG. 8 is a flow chart depicting example blocks performed by the assessment client software of FIG. 7;

FIG. 9 illustrates a tag as may be affixed to an article in an example embodiment; and

FIG. 10 illustrates an example screen display of the client device of FIG. 6.

### DETAILED DESCRIPTION

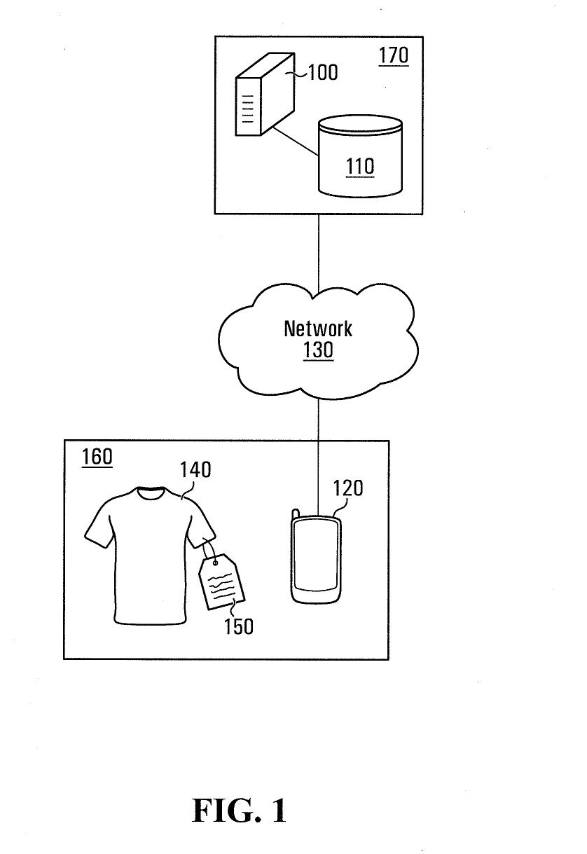

FIG. 1 is a schematic block diagram illustrating the operating environment of an example embodiment.

As illustrated, an article 140, illustrated by way of example as a t-shirt, is provided in association with a tag 150. The article is accessible to consumers in an environment 160. Environment 160 may be an environment where physical goods are offered to potential customers such as a store, kiosk, some other point-of-sale, or the like.

Article 140 is presented to possible consumers as a genuine specimen authorized by a source. For example, article 140 may be a presented as a genuine article of clothing from a brand name manufacturer. In some cases, article 140 may be a mass-produced article. In other cases, article 140 may be a limited edition article such that a manufacturer or distributor only makes a fixed number of such articles available worldwide or in a given locale.

Genuine specimens of articles authorized by the source are provided in association with an identifier unique amongst such genuine specimens. In the example illustrated, such an identifier is provided on tag 150 associated with article 140.

Tag 150 may be of a group of tags, each with a unique identifier, purchased or produced by a source of goods. In this way, a source of goods may have an inventory of each of the unique identifiers as may be associated with genuine specimens of a particular article. For example, a source may maintain a record that tag 150 is associated with a t-shirt of the style of article 140. In some cases, a source of goods may maintain records associating each specimen of an article with a particular unique identifier. For example, where article 140 is unique amongst genuine specimens such as, for example, because it is a limited edition article, is serial numbered or it has some other individuality such as, for example, being hand painted, or simply because the manufacturer wishes to identify every ‘identical’ item by a unique identifier such as, for example, a serial number, then a source of goods may maintain records associating the unique identifier of tag 150 with article 140 specifically as amongst similar articles.

Tag 150 is illustrated by way of example as attached to article 140 with a thread, but may also be attached to or integrated into article 140 in a variety of ways, such as, for example, by way of a plastic fixing attachment or the like, a sewn-in tag, printing applied directly to article 140, markings laser-etched onto article 140, or incorporation into a document such as a certificate of authenticity associated with article 140.

A client device 120 is also present in environment 160. Client device 120 is typically carried by a consumer looking to purchase article 140, and may be a mobile device such as, for example, a tablet, smart phone, PDA, smart watch, or the like. Client device 120 is associated with a potential consumer (not illustrated). For example, a potential consumer may own client device 120 and bring device 120 to environment 160—as a consumer might bring his/her mobile device (e.g. smart phone, tablet, or smartwatch), with them to a store.

Client device 120 is in communication with a server 100 via a network infrastructure 130. Network infrastructure 130 may be the Internet, a wide-area network, or the like. Client device 120 may access network infrastructure wirelessly, such as, for example, by way of WiFi, Bluetooth, a cellular data network or the like. Additionally or alternatively, client device 120 may access network infrastructure via a wired connection, such as, for example by way of a modem connected to a POTS telephone line or by an Ethernet connection.

Server 100 may be operated by or on behalf of an authentication service provider that provides services to sources of goods to allow potential consumers to receive an estimate of the likelihood that goods offered for sale are genuine products from the source. For example, an authentication service provider may be contracted to provide its services by a source of goods such as manufacturer, a distributor, an importer, or the like. Alternatively, server 100 may be operated by a source of goods directly.

Server 100 is in a remote location—i.e. environment 170 such as a data center, cloud service provider, the premises of an authentication service provider, the premises of the source of goods, or the like. Remote environment 170 is remote from environment 160.

Server 100 is in communication with a database 110 in remote environment 170 that is used to store information regarding goods and other articles for which authentication services may be offered. Database 110 may also be used to store related information as may be used for provision of other services such as, for example, other services related to the wares such as, for example, the provision of information regarding warranties and the like.

Database 110 may be operated on a separate computing device from server 100. Server 100 may be in communication with database 110 via a network or similar data communications, such as, for example, a LAN or a SAN, using infrastructure such as, for example, an Ethernet network, Fiber Channel, or the like.

Additionally or alternatively, the information stored in database 110 may be stored in a further remote environment such as, for example, where database 110 is instead located in a further remote environment accessible by way of, for example, a LAN or WAN, or where data is replicated to additional storage in such a further remote environment such as to provide enhanced availability or redundancy.

Additionally or alternatively, the information stored in database 110 may be encrypted, such as by way of encryption keys according to public-key encryption algorithms such as, for example, RSA or elliptical curve cryptography, or using symmetric-key encryption algorithms such as, for example, DES, 3DES, IDEA, Blowfish, AES, or the like.

As will become apparent, client device 120 may be used by a potential consumer in environment 160 to collect the identifier presented on tag 150 and to communicate that identifier to server 100 so as to obtain an estimate therefrom of the likelihood that article 140 is genuine. In this way, a potential consumer in environment 160 may, by way of client device 120, obtain an estimate, from that source or from an authentication service provider, of the likelihood that an article purporting to be from a particular source of goods is genuine. For example, server 100 may be operated by an authentication service provider acting as a delegate of a source of goods by providing authentication of articles on their behalf.

Using networked devices in this way, potential consumers may obtain an instant assessment of the likelihood goods are genuine, without specialized knowledge of the goods, and at a location remote from the source.

Using network devices to offer authentication services allows sources of goods or authentication service providers the opportunity to provide authentication services related to goods at many locations without the necessity of providing equipment or personnel at each location.

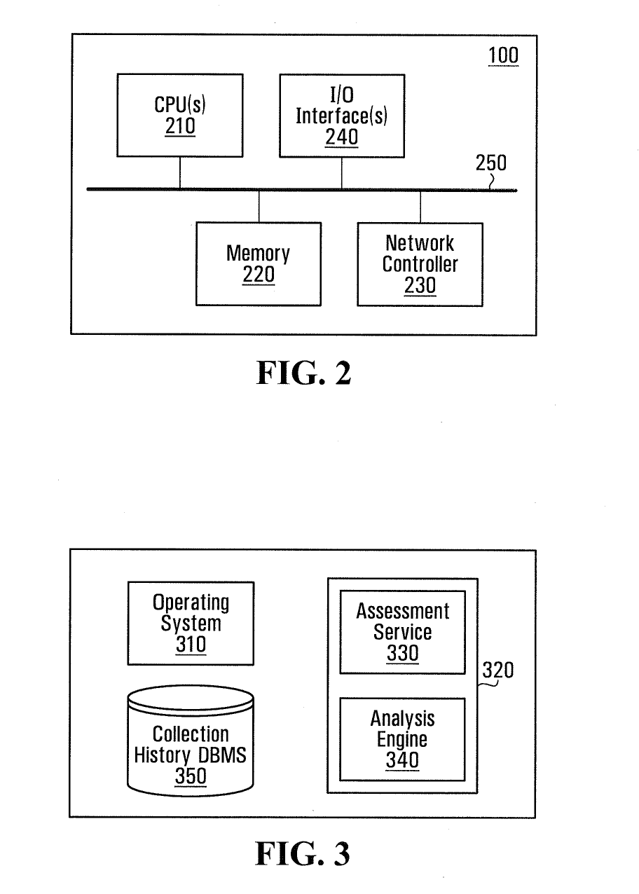

FIG. 2 is a high-level block diagram of a computing device, exemplary of server 100 in an embodiment. As will become apparent, the computing device includes server software that provides an assessment of whether articles are genuine.

As illustrated, server 100, a computing device, includes one or more processors 210, a memory 220, a network controller 230 and one or more I/O interfaces 240 in communication over bus 250.

One or more processors 210 may be one or more Intel x86, Intel x64, AMD x86-64, PowerPC, ARM processors or the like.

Memory 220 may include random-access memory, read-only memory, or persistent storage such as a hard disk, a solid-state drive or the like. Read-only memory or persistent storage is a computer-readable medium. A computer-readable medium may be organized using a file system, controlled and administered by an operating system governing overall operation of the computing device.

Network controller 230 serves as a communication device to interconnect the computing device with one or more computer networks such as, for example, a local area network (LAN) or the Internet.

One or more I/O interfaces 240 may serve to interconnect the computing device with peripheral devices, such as for example, keyboards, mice, and the like. Optionally, network controller 230 may be accessed via the one or more I/O interfaces.

Software comprising instructions is executed by one or more processors 210 from a computer-readable medium. For example, software may be loaded into random-access memory from persistent storage of memory 220 or from one or more devices via I/O interfaces 240 for execution by one or more processors 210. As another example, software may be loaded and executed by one or more processors 210 directly from read-only memory.

FIG. 3 depicts a simplified organization of example software components stored within memory 220 of server 100. As illustrated these software components include operating system (OS) software 310, assessment server software 320, and collection history database management system software 350.

OS software 310 may be, for example, Microsoft Windows, UNIX, Linux, Mac OSX, or the like. OS software 310 allows assessment server software 320 and collection history database management system software 350 to access one or more processors 210, memory 220, network controller 230, and one or more I/O interfaces 240 of the computing device.

Assessment server software 320 adapts server 100, in combination with OS software 310 and collection history database management system software 350, to operate as a server for providing an assessment of the likelihood that the article corresponding to an identifier is genuine.

Collection history database management system software 350 allows server 100 under control of assessment server software 320 to access and maintain information related to articles and the collection of identifiers associated with articles. Collection history database management system software 350 may be used to access and/or manage information stored in database 110. For example, collection history database management system software 350 may include client software used to access a database 110 such as JDBC (Java Database Connectivity) drivers, ODBC (Open Database Connectivity) driver, an OLE DB provider, an ADO.net provider, or the like. Additionally or alternatively, collection history database management system software 350 may include software adapted to manage the contents of database 110.

Assessment server software 320 may include one or more submodules. As illustrated, assessment server software 320 includes assessment service submodule 330 for communicating with client devices and analysis engine submodule 340 for performing analytics to analyze information such as information related to the collection of identifiers associated with articles. Information analyzed by analysis engine 340 may be stored or accessed by way of collection history database management system software 350.

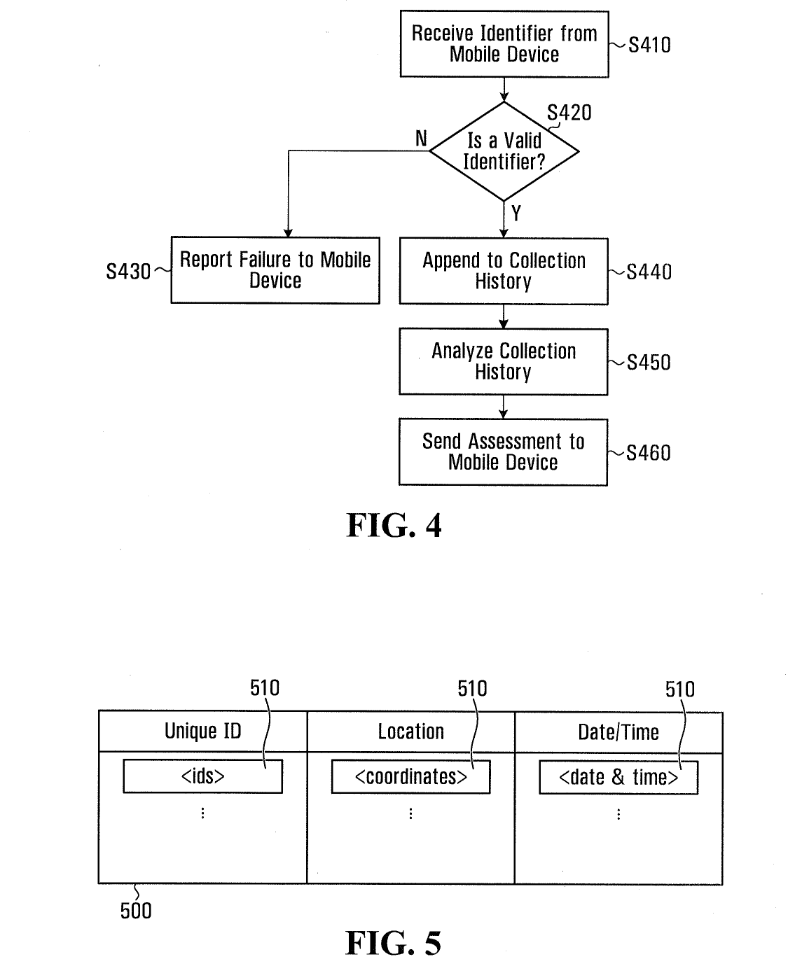

The operation of the assessment server software 320 is described with reference to the flowchart of FIG. 4. Blocks S410 and onward are performed by one or more processors 210 executing assessment server software 320 at server 100.

At block S410, one or more processors 210 receive, from client device, such as by via network controller 230, an identifier associated with an article purporting to be genuine, read from an associated tag 150 (FIG. 1). For example, the identifier may be received according to a request from client device 120 processed according to assessment service submodule 330. Further information relating to the collection of the identifier may also be received such as, for example, location of client device 120 at the time of collection and the date and/or time of the collection. Client device 120 may also send additional information such as, for example, information related to client device 120 itself such as, for example, versions of client software, device make/model, IMEI (International Mobile Station Equipment Identity), telephone number, IP address, MAC identifier, or information about the subscriber of client device 120 such as, for example, their name or telephone number.

At block S420, one or more processors 210 evaluate the identifier received at block S410 to determine whether it is a valid identifier. Identifiers may be structured according to a schema such as, for example, by allocating certain digits of a fixed length identifier to store particular information, by including pre-determined symbols denoting length or acting as delimiters between various fields of the identifier, by formatting the delimiter as a URL or URI and encoding information therein using techniques as may be known to skilled persons for encoding structured information in URLs or URIs, or the like. One or more fields of a structured identifier may be encrypted such as with an encryption key known only to the source of the goods or to the authentication service provider. Validation may include for example, checking whether an identifier is in an expected structured format, whether the fields of a structured identifier conform to a schema, whether an identifier is of a set of known identifiers, or whether an identifier conforms to an embedded checksum by way of a mathematical calculation over the digits of the identifier. For example, a checksum may be verified according to various checksum algorithms such as, for example, a parity bit, the Luhn check algorithm, or by way of some other mathematical calculation selected for identifying either accidental errors, such as may occur, for example, due to an error reading the identifier from a tag, or for identifying more intentional errors, such as may occur, for example, if a person is attempting to produce counterfeit tags, or both.

As discussed, records identifying particular identifiers as associated with genuine specimens of particular articles may be maintained. As an example, a list of known identifiers may be stored or accessed from a database such as, for example database 110, as may be accessed by way of, for example, collection history database management system software 350. Identifier validation may include verifying that a received identifier is a known identifier according to such records such as, for example, by way of a database query.

If the identifier is valid, control flow proceeds to block S440, else to block S430.

At block S430, an identifier validation failure is reported to client device 120 by sending to the client device using network controller 230. For example, the failure may be reported by a reply to client device 120 according to assessment server submodule 330. Optionally, information relating to the failed collection may be appended to a history, such as possibly the collection history, or a log. Such a log or history may be maintained in a table such as may be maintained using collection history database management system software 350 or in some other form such as, for example, a text file or structured log as may be stored in, for example, memory 220.

At block S440, information received from mobile client device 120 relating to the collection of the identifier is appended to the collection history. In the example embodiment, the collection history is maintained as a database table using collection history database management system software 350.

FIG. 5 is a schematic illustration of a collection history that may, for example, be suitable for storage as a database table, using collection history database management system software 350.

Collection history table 500 is illustrated as having three columns. It may, of course, include other columns, or be otherwise organized.

A first column of collection history table 500 is labelled “unique id” and is illustrated as storing unique identifiers 510, one per row. The format of the unique id may be that of identifiers provided with articles as collected by the client device or may be in an alternative format. For example, only some fields of the unique id may be stored or unique ids may be transformed, such as to, for example, remove the checksum or extract certain fields of a structured identifier, prior to storage. Alternatively, an alternate identifier as may be correlated with the identifiers provided with articles may be stored in the table.

A second column of collection history table 500 is labelled “location” and may store location coordinates 520, one per row. Location coordinates represent the location of client device 120 at the time of collection of the corresponding identifier and may be of a variety of formats such as, for example, GPS co-ordinates representing longitude and latitude, co-ordinates according to some proprietary geolocation scheme, or may not be coordinates but may additionally or alternatively store semantic location information, such as may have been received from the client device or derived from information received therefrom, such as, for example, an IP address, a city name, a store location, or a ZIP or postal code.

A third column of collection history table 500 is labelled “date/time” and may store date and time information 530, one entry per row. Date and time information represents the time and/or date at the time of collection of the identifier associated with that row. Additionally or alternatively, date and time information may represent another date related to the collection of the identifier associated with that row such as, for example, the time and/or date at which the notification of the collection is received at or transmitted to server 100. Date and time information may be stored in a variety of formats such as calendar dates, times, or seconds or other some other time unit as may have elapsed since some epoch such as, for example, according to the POSIX or UNIX time formats.

The description of collection history table 500 is in no way limiting. For example, as known to persons skilled in the art, the same data may be represented in a variety of formats in a database. For example, different formats may be derived by applying techniques as known to persons skilled in the art such as, for example, normalization, de-normalization, horizontal and vertical partitioning or combinations thereof. Additionally or alternatively, collection history table 500 may have additional columns storing other information such as may relate to the article associated with particular unique ids—for example, a given row of collection history table 500 could also store information relating to the make, model, color, or the like. Additionally or alternatively, information relating to a client device collecting a unique identifier may be stored in collection history table versions 500 such as for example, versions of client software, device make/model, IMEI (International Mobile Station Equipment Identity), telephone number, IP address, MAC identifier, or information about the subscriber or user of a mobile device such as, for example, their name, email address, or telephone number. Alternatively, such other information may be stored in another table as may be associated with collection history table 500 such as, for example, by way of a relational database “join” operation or the like. Alternatively, collection history database management system software 350 may use a data model other than tables with rows and columns. For example, a data model may be structured using nodes and pointers or may be semi-structured and stored in formats such as, for example, using XML. Returning to FIG. 3, at block S450 one or more processors 210 analyze the collection history for the identifier to generate an estimated likelihood that the collection history corresponds to the movement and/or identifier collection of a genuine specimen of the product. For example, the analysis may include performing one or more analytical techniques or heuristics such as, for example, according to analysis engine submodule 340.

For example, analysis may involve a query of collection history table 500 using collection history database management system software 350 to retrieve the rows of collection history table 500 for the identifier. As another example, the query of collection history table 500 may be configured to only retrieve n, for example n=2 or n=20, most recent collections of the identifier. In a further example, the query may be configured to extract only collections of the identifier at/near specified locations, within a particular time window, or according to additional metadata as may be optionally stored in collection history table 500 or another table that is correlated with collection history table 500 such as, for example, by way of a database table join operation.

Analysis may include comparing retrieved rows of the collection history table such as comparing the current collection to the previous collection or comparing the last n collection for some integer n.

Analysis may involve logic comparing the location of collection, time of collection, or some combination thereof.

For example, locations may be compared to a list of one or more authorized locations to determine whether collection occurred at an authorized location for the identifier or, alternatively, within some predetermined distance therefrom.

In another example, locations may be compared to one or more geo-fences outlining authorized territory for the article associated with the identifier. For example, locations may be compared to one or more polygons, their vertices described by one or more coordinates or some other metes-and-bounds description, the polygons serving to outline one or more authorized territories against which the locations are compared in order to determine whether the collections occurred inside an authorized territory.

In yet another example, the time and location of one or more collections may be compared to those of one or more previous collections in order to determine a time interval and distance which may then be analyzed. As an example, a time interval and a distance may be used to compute a speed which may then be compared to a threshold speed. For example, in this way, duplicate tags, as may be affixed, for example, to counterfeit articles, may be detected.

Additionally or alternatively, analysis may involve a query of collection history table 500 to retrieve rows of collection history associated with related articles from that source, such as, for example, other articles of the same make, model, or class. For example, rows corresponding to other t-shirts of the same design as article 140 may also be retrieved when analyzing the collection history of the unique identifier associated with article 140. Collection histories associated with related articles may be compared to determine if, for example, a particular location or environ is a source of frequent collections. In some cases, such as where goods are widely distributed, a collection history similar to related articles may be indicative of an article following the ordinary chain of commerce. For example, articles in a store may be expected to have an associated collection history suggesting they are staying in roughly the same place. As another example, the scan frequency of particular types of articles may be expected to be roughly similar for related articles in similar environments. Articles following the ordinary chain of commerce may be more likely to be genuine than articles with atypical collection histories.

In some embodiments, collection histories may be used to refine analytical algorithms. For example, machine learning techniques may be applied to collection histories of collection history table 500 such as, for example, by training a classification algorithm on related collection histories may determine features pertinent in determining whether a particular classification history is similar or different from other known collection histories. Additionally or alternatively, analytical techniques may be refined based on collection histories associated with known authentic or known counterfeit items. For example, authentic items may be entered into the chain of commerce in a controlled manner so as to permit gathering collection histories known to belong to a genuine article for use refining analytical algorithms. Additionally or alternatively, collection histories associated with known counterfeits such as, for example, items seized in enforcement against counterfeiters, may be added to training sets used to refine algorithms adapted to identifying likely counterfeits. In this way, analytical techniques may be adapted and improved by over time.

Additionally or alternatively, analysis may involve an assessment of information about the client device or the user of the client device associated with one or more of the rows of collection history table 500 associated with the identifier. Additionally or alternatively, analysis may also involve comparison to information about a client device or the user of a client device associated with one or more of the identifier collections recorded in the rows of collection history table 500 associated with related articles from that source. For example, if the variety of users and/or devices associated with collections of a particular identifier is more or less than is typical such as, for example, according to a comparison with collection histories of related articles, then this may correspondingly be indicative of a lower or greater likelihood that an article is counterfeit. In another example, if particular users or client devices repeatedly collected identifiers associated with suspected counterfeit articles then the analysis may suggest that other articles scanned by those same users or client devices may be more likely to be counterfeit.

The analysis may also combine one or more of these analytical techniques together or with one or more other example techniques.

The analysis may involve retrieval of a cached result of one or more analytical techniques. For example, an estimate may be cached in association with an identifier and may be updated only periodically such as, for example, at some time interval or every so many collections. As another example, analytical techniques that are time-intensive may only be run periodically while analytical techniques that are less time or computationally intensive may be run more frequently or on demand for each collection. Additionally or alternatively, time-intensive analytical techniques may be run asynchronously from the collection.

The analysis results in some likelihood estimate of whether the collection history corresponds to movement and/or identifier collection of a genuine specimen of the product. The estimate may be for example binary (e.g. genuine, not genuine), expressed as a probability (0.0-1.0), expressed as a fuzzy estimate (e.g. low, medium, high) or expressed in some other format.

Notably, applying analytical techniques over time to a growing collection history may permit estimates to be refined over time. For example, it may become apparent due to the disparate locations, service providers, users, or the like in a collection history associated with a particular identifier is indicative of a collection history consistent with a tag that has been fraudulently duplicated. As another example, as a collection history grows it may become more or less apparent that a particular collection history is more or less consistent with that typical of a genuine article such as when, for example, with additional collections it becomes apparent that the movement history of a good is more consistent or less consistent with the movement of goods expected in the ordinary chain of commerce than may have been earlier estimated. In another example, it may become apparent that a collection history is more consistent or less consistent with a collection history expected of an identifier associated with an article in an ordinary retail environment such as according to the frequency of collection, variety of devices or users collecting the identifier, etc. Correspondingly, the estimate of the likelihood an article is authentic may be correspondingly raised or lowered over time even if, according to the collection history of an associated identifier, the article moves around or, alternately, stays in roughly the same location.

Notably, where analytical techniques are applied comparing collection histories amongst related items, the estimate as to whether or not a first article is genuine may be refined even if only the collection histories of related articles markedly grow as this may still permit greater refinement of an understanding of a typical collection history.

In some embodiments, the analysis may also produce a representation of the confidence, based on the analysis, that the likelihood estimate is sound. For example, as collection history for an article grows, an analysis of a collection history including additional collections of an identifier may permit an estimate with a greater confidence as to whether or not that collection history corresponds to a genuine specimen. Additionally or alternatively, confidence may be based on a comparison of a collection history for an identifier to that of related articles—for example, where the collection histories are similar there may be greater confidence in the likelihood estimate than where the collection histories are disparate. Additionally or alternatively, as analysis techniques are refined as discussed previously, confidence in estimates may be increased such as due to greater confidence such as may flow from refinements in analytical techniques.

Confidence may be represented, for example, as a probability (0.0-1.0) expressing a likelihood that the estimate is correct, or as fuzzy representation of how much an estimate is correct such as, for example, high confidence, medium confidence, low confidence. Additionally or alternatively, confidence may be reflected in the estimated likelihood itself. For example, a likelihood estimate may be represented as a range spanning over a confidence interval. A narrower range may correspond to higher confidence in a likelihood estimate as compared to a broader range which may correspond to a lower confidence.

At block S460 one or more processors sends, using network controller 230, an assessment to the client device, the assessment is based on the likelihood estimate. For example, the assessment may be reported by a reply to the client device according to assessment server submodule 330.

Assessment server software 320 may optionally incorporate one or more security features in order to limit fraudulent or nuisance scan activity. For example, identifiers that are collected repeatedly may be temporarily disabled. In another example, a client device sending many requests in short-succession may be temporarily ignored. In yet another example, a client making too many requests for the same identifier may be ignored only in relation to that identifier.

In alternate embodiments, the assessment server may not maintain a collection history and may only analyze the information relating to the current collection of the identifier such as, for example, by comparing the collection location to an authorized location or authorized territory substantially as described above. In yet other embodiments, the assessment server analysis may involve inspection of the identifier itself such as by verifying a structured identifier conforms to a schema, has a valid checksum, or by verifying the integrity of encrypted data of one or more fields of a structured identifier.

In alternative embodiments, the assessment server may maintain the collection history in another format than a database such as, for example, using a text file such as a CSV (comma separated values), TSV (tab separated values), an XML file in persistent storage of memory 220 or, additionally or alternatively, a data structure in random access memory of memory 220.

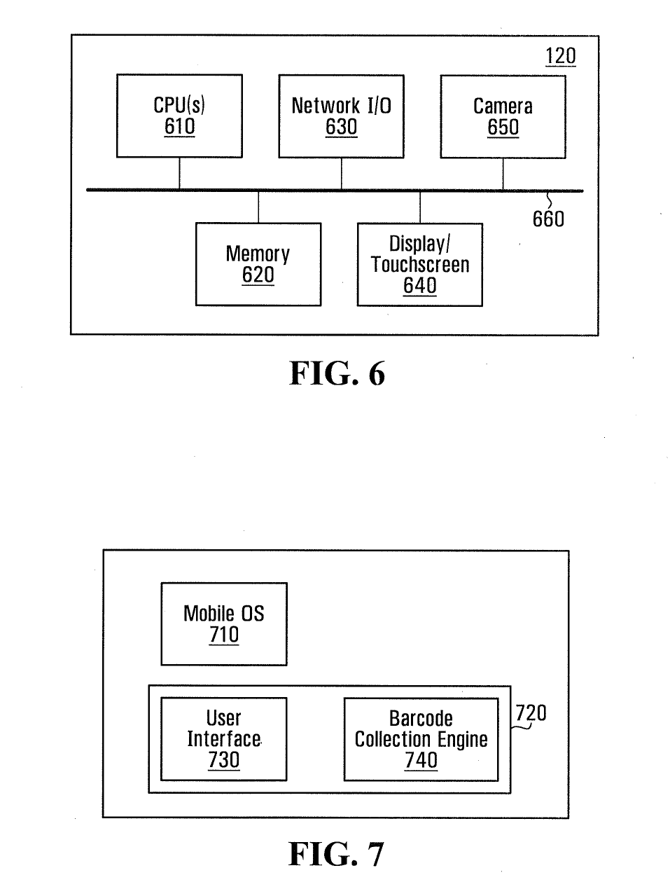

FIG. 6 is a high-level block diagram of a computing device, exemplary of client device 120 in an embodiment. Client device 120 may be a smart cellular telephone, tablet, personal digital assistant, smart watch, or other computing device. Typically, client device 120 will be portable allowing a customer to bring device 120 to an environment where goods are on sale or display.

As illustrated, client device 120 may include one or more processors 610, a memory 620, network I/O device 630, display 640, and camera 650 in communication over bus 660.

One or more processors 610 may be one or more Intel x86, Intel x64, AMD x86-64, PowerPC, ARM processors or the like.

Memory 620 may include random-access memory, read-only memory, or persistent storage such as solid-state memory, flash memory, or the like. Read-only memory or persistent storage is a computer-readable medium. A computer-readable medium may be organized using a file system, controlled and administered by an operating system governing overall operation of the computing device.

Network I/O device 630 serves as a communication device to interconnect computing device 120 with one or more computer networks such as, for example, a cellular network and/or the Internet. For example, network I/O device 630 may communicate using a cellular network to transmit and receive data according to protocols such as GPRS, HPSA, LTE, or the like. Alternatively or additionally, network I/O device 630 may communicate using WiFi, Bluetooth, ZigBee, or the like. For example, network I/O device 630 may be used by client device 120 for communication with network infrastructure 130.

Display 640 provides a display with an integrated touchscreen that serves to display user interface and receive input from a user. For example display 640 may be an LCD display integrated with or layered with a capacitive or resistive touch sensor adapted to receiving input by way of a user's tactile interaction with the display. As an example, a user may be permitted to interact by way of touch with a virtual keyboard displayed on display 640.

Camera 650 is an interface to a digital camera adapted to capturing images from the physical environment. For example, camera 650 may utilize a CMOS or CCD sensor to capture images from an integrated lens. Camera 650 may integrate with logic to focus images on the sensor and may work in tandem with a photographic flash, such as, for example an LED flash integrated into client device 120.

Software including instructions to be executed by one or more processors 610 from a computer-readable medium is stored at device 120. For example, software may be loaded into random-access memory from persistent storage for execution by one or more processors 610. As another example, software may be loaded and executed by one or more processors 610 directly from flash memory.

FIG. 7 depicts a simplified organization of example software components stored within memory 620 of client device 120. As illustrated these software components include mobile operating system (OS) software 710 and assessment client software 720.

Mobile OS software 710 may be, for example, Microsoft Windows Mobile, Apple iOS, Google Android, or the like. Mobile OS software 710 allows assessment client software 720 to access one or more processors 610, a memory 620, network I/O device 630, display 640, and camera 650 of the computing device.

Assessment client software 720 adapts the computing device, in combination with Mobile OS software 710, to operate as a client device for providing users with an assessment of the likelihood that the article that corresponds to an identifier is genuine.

Assessment client software 720 may comprise one or more submodules. As illustrated, assessment client software comprises user interface submodule 730 for providing visual display to and receiving input from users and barcode collection engine submodule 740 for collecting identifiers presented as barcodes affixed to, attached to, or otherwise associated with an article.

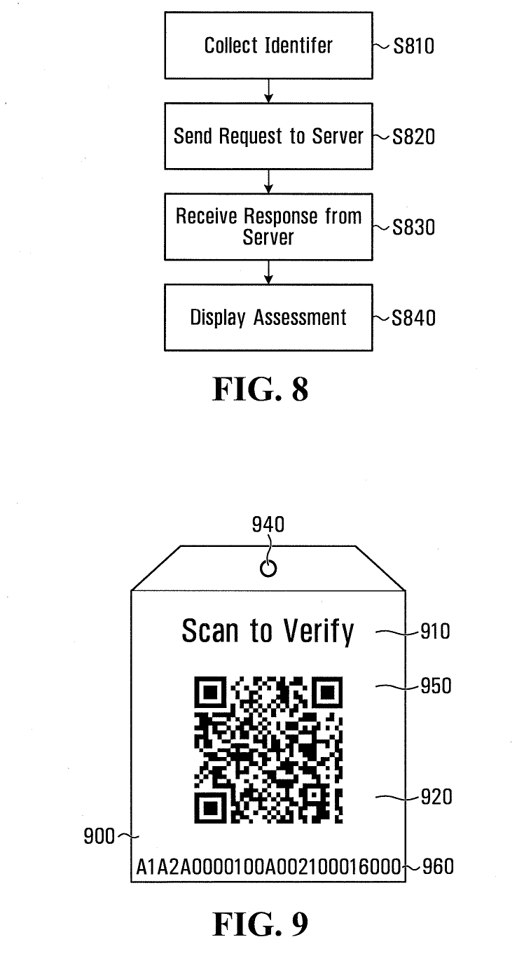

The operation of the assessment client software 320 is described with reference to the flowchart of FIG. 8. Blocks S810 and onward are performed by one or more processors 610 executing assessment client software 720 at client device 120.

At block S810, processor(s) 610, collect(s) an identifier from tag 150. Collection of an identifier may be triggered by user input such as, for example, by input received via the integrated touchscreen of display 640. Such a user interface for collection may be displayed according to user interface submodule 730.

Collection may utilize barcode collection engine submodule 740 to collect the identifier such as, for example, by collection of a barcode printed on the article or a tag or other means for providing a barcode in association with the article.

For example, one or more processors 610 may use camera 650 to collect an image of a 1D barcode represented according to a 1D symbology such as, for example, Code3of9, UPC, CODABAR or the like and decode that image using barcode collection engine submodule 740.

In another example, one or more processors 610 may use camera 650 to collect an image of a 2D barcode represented according to a 2D symbology such as, for example, Quick Response (QR) code, Data-Matrix, Aztec, PDF417, or the like and decode that image using barcode collection engine submodule 740.

Alternatively, the identifier may be collected using the mobile device by way of a media reader other than a camera. For example, identifiers may be collected by way of a barcode scanner, an imager, or the like. Such media readers may be integrated into a client device or, alternatively, may be a separate peripheral in communication with a client device such as by way of a wired connection such as, for example, using USB or RS-232, or by way of a wireless connection such as, for example, by way of a WiFi or Bluetooth connection.

FIG. 9 illustrates an example barcode tag encoding an identifier as may be provided in association with an article. For example, example barcode tag 900 may be attached using attachment hole 940 such as how tag 150 is attached to article 140.

Example barcode tag 900 includes a barcode 920 encoded as a QR code. The payload of barcode 920 is structured as a URL that may be represented with plaintext as “http://www.checkreal.com/CheckReal.html?˜12˜A1A2A0000100A002100016000˜” (no quotes) indicating an identifier A1A2A0000100A002100016000. Alternatively, the payload of barcode 920 may take some other form such as, for example, merely encoding the identifier. Optionally, the encoded URL may be such that if the barcode is scanned using a generic QR code reader to obtain the URL and the URL is then accessed using a generic web browser then the user may be provided with information about installing assessment client software. Alternatively, the user may be prompted to install the client software such as, for example, by way of a redirect to an appropriate “app store” such as for example, according to metadata in the HTTP request by the web browser whereby Android devices may be redirected, for example, to the Google Play store and Apple devices to the iTunes App Store.

Example barcode tag 900 may include human-readable elements, such as instruction text 910 and human-readable identifier 960.

Instruction text 910 instructs a user how to verify the article associated with example barcode tag 900. Optionally, further text may be provided offering additional information such as information about the product or instructions on how a user may install client assessment software on their device.

Human-readable identifier 960 provides a human readable form of the identifier A1A2A0000100A002100016000. Human-readable identifier 960 may be used, for example, to permit a user to visually verify that barcode 920 was correctly scanned. Alternatively, human-readable identifier 960 may be read and entered into the client device, such as by keying on a virtual keyboard displayed on display 640 if, for example, barcode 920 is damaged or otherwise cannot be properly scanned.

Returning to FIG. 8, at block S820 a request is sent to an authentication server using network I/O device 630. The request contains an indication of the identifier and may also contain other information such as, for example, location information and date/time information or other information about the client device such as telephone number, IMEI, or the like. Location information may be collected at client device 120 such as by way of, for example, an integrated GPS receiver (not illustrated) or additionally or alternatively by triangulation between cellular towers or by identification of nearby WiFi hotspots such as may be detected using network I/O device 630.

In some embodiments, a client device may select amongst one or more authentication servers according to the identifier such as, for example, according to one or more fields of a structured identifier as may identify a server address, a source of goods associated with the identifier, or the like. In this way, a user may be directed to an appropriate authentication server for obtaining an estimate without requiring a user to specifically select a server, unlike in a manual system where a user has to contact a specific person associated with a source and/or place a call to a particular call center.

At block S830, a response is received using network I/O device 630 from the authentication server, the response containing an assessment of the likelihood that the article that corresponds to the scanned identifier is genuine.

At block S840, the assessment is presented to the user such as by way of a visual representation displayed via display 640. Additionally, or alternatively, the assessment may be presented to the user by way of an audio representation using client device 120. The presentation may be by way of a user interface according to user interface submodule 730.

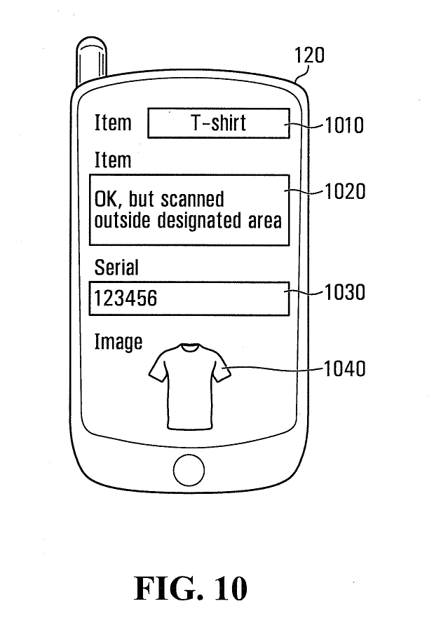

FIG. 10 illustrates an example screen display as may be used to present an assessment to a user of mobile device 120 such as according to user interface submodule 730.

The assessment is displayed using status text 1020 indicating that the example identifier is assessed as likely genuine but with a caution that the identifier was scanned at a location outside the authorized area. Optionally, the assessment may instead be presented using a visual representation such as a gauge, a bar, traffic light colors (green, yellow/amber, red), or a combination thereof. As an example, status text 1020 could be presented on a yellow background to illustrate that some caution is warranted due to the article in the example being scanned outside the authorized territory.

Additional product information may be sent by the assessment server and received by client device 120 for presentation to the user. For example, assessment server 100 may obtain additional product information from database 110 for sending to client device 120. Alternatively, product information may be retrieved from some other source such as, for example, local storage in memory 620 or from another server other than the assessment server from which the assessment was received.

Additional product information may include, for example, a description of the genuine article, warranty information, a picture of what a genuine article should look like, or information about the serial number of a genuine article associated with the identifier. For example, the example screen display of FIG. 10 includes description text 1010 describing the genuine article, genuine article serial number 1030, and genuine article picture 1040, each providing additional information about the genuine article associated with the collected identifier.

Assessment client software 720 may provide functionality additional to providing users with an assessment of the likelihood that the article that corresponds to an identifier is genuine.

As an example, assessment client software 720 may permit users to add a product associated with a scanned identifier to a “wish list”. The “wish list” may be used by a user to maintain a list of articles of interest, such as, for example articles that a user may wish to purchase. A “wish list” may be maintained for example on a server or at client device 120.

As another example, assessment client software 720 may permit a user to report suspected counterfeits. For example, a user may be enabled to photograph an article using camera 740 and that picture may then be uploaded or forwarded to a server maintained by a source of genuine articles such as the manufacturer or authorized distributor. The picture may then be utilized by the source in planning, for example, more targeted enforcement against potential dealers in counterfeit goods such as at a location where suspected counterfeits are reported. Optionally, the upload may also include additional data such as the location where the picture was taken, the identifier on the tag associated with the suspected counterfeit (if any), date and/or time, or other information such as information about client device 120 such as may, for example, aid in enforcement efforts. In this way, a source may “crowdsource” information about suspected counterfeits from a variety of locations without sending personnel to those locations by instead receiving information from users via their client devices in communication with the server.

As yet another example, assessment client software 720 may maintain a history of prior identifier collections and may permit a user to review information about those past scans such as, for example, allowing a user to obtain information such as is presented in the screen display of FIG. 10 but regarding past collections rather than a current collection of an identifier.

In some embodiments, identifiers may be recorded at point-of-sale by a retailer or via additional functionality of assessment client software 720 so as to record that an article was sold. This sales information may be associated with a user of assessment client software 720 such as, for example, by way of a user name or email address so as to record that the user was the purchaser of an article. Sales information may be presented to a user, such as for example, by way of one or more additional fields added to the screen display of FIG. 10.

In another example, assessment client software 720 may permit communication with the purchaser of a genuine article such as to, for example, allow sources of genuine articles to provide consumers with recall, repair, or warranty information.

In yet another example, assessment client software 720 may provide users with a record of past purchases according to associated sales information. Such a record may include purchase related information such as, for example, recall, repair, or warranty information.

In a yet further example, assessment software 720 may be used to provide marketing associated with a user's collection or purchase history. For example, a user may be presented with coupons, promotions, and/or advertisements relating to products in the user's histories such as, for example, relating to an article associated with a collected identifier. A user may also be presented with coupons, promotions, and/or advertisements relating to products related to products in the user's histories such as, for example, relating to products related to an article associated with a collected identifier. For example, a user scanning a handbag may be provided with coupons, other promotions, and/or advertisements relating to handbag accessories or matching clothing.

In some embodiments, collection histories may be analyzed to identify frequent collection locations. These frequent locations may then be compared to authorized locations or authorized sales territories. This may permit, for example, a source of goods to determine if authentic product is being diverted to unauthorized resellers or the location of retailers possibly selling counterfeits with fraudulent tags.

In some embodiments, sources of genuine articles may be provided with reporting functionality. For example, sources of genuine articles such as, for example, manufacturers or authorized distributors may be provided with reports about collection history of identifiers and/or purchase history of articles for which they are the source. Reporting to sources of genuine article may include information about “where, when, and who” collected identifiers associated with articles from that source. For example, a source of genuine articles may be informed about the one or more locations where identifiers associated with their articles were collected, the time and or date of such collections, information about client devices used to collect those identifiers such as, for example, make/model, service provider, or the like. Additionally or alternatively, a source of genuine articles may be provided with information about the owner and/or user of client devices used to collect identifiers associated with articles from that source such as, for example, names or demographic information such as, for example, age, income, home address, or the like. Information about owners or users may be provided individually or on an aggregate basis such as, for example, to identify trends or preserve privacy. Reporting functionality may benefit sources of genuine articles such as, for example, by enabling them to understand product exposure, review effectiveness of marketing initiatives, analyze product comparisons, link product exposure to sales, or the like.

In some embodiments, the identifier may be encoded using means other than or even additional to a barcode. For example, the identifier may be represented using an RFID tag as may be scanned by a client device such as for example, by using, NEC (near-field communication) functionality. Capability for reading NFC or RFID tags may be integrated into a client device or, alternatively, an external RFID or NFC media reader in communication with a client device such as by way of a wired connection such as, for example, using USB, or by way of a wireless connection such as, for example, by way of a WiFi or Bluetooth connection.

In some embodiments, a web browser may serve as the client device. For example, a user may be presented with a web page where an identifier may be entered. The web browser may then provide the identifier to the server such as, for example, by way of an HTTP POST request. In another example, a barcode may be provided such as may be scanned, for example, using a generic QR code reader, the barcode encoding a URL that includes an identifier such that the URL, when accessed using a web browser, supplies the identifier to a server so that an assessment of whether the associated article is genuine can be obtained. In either example, the web browser may also provide additional metadata in the request such as, for example, information about the client device or location.

As will now be appreciated, potential consumers may benefit from tools for authentication of goods and other articles that can be used in determining the likelihood as to whether the wares are genuine. Manufacturers and other sources of articles may benefit from systems that report where possible counterfeits may be being offered for sale. Manufacturers may also benefit from receiving information about potential consumers and their shopping habits and review of articles for sale, Manufacturers may additionally benefit from being able to send promotions, coupons and advertising directly to consumers at point of sale, which may result in business benefits such as, for example, additional sales of the manufacturers' wares.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A method of providing a potential consumer with an assessment of whether an article is genuine, by a server in communication with a mobile device, said article purporting to be a genuine specimen of a product authorized by a source, wherein genuine specimens of said product from said source have affixed thereto an identifier unique amongst said genuine specimens, said method comprising:
receiving, at said server from said mobile device, a request initiated by said potential consumer, said request comprising a notification of a reading, by said mobile device, of an identifier affixed to said article and an indication corresponding to the location of said mobile device at the time of said collection;
appending, to a collection history associated with said identifier, an entry comprising said indication corresponding to the location of said mobile device at the time of said collection and an indication corresponding to the time of said collection, said collection history comprising a plurality of entries, each entry corresponding to a collection of said identifier by a mobile device;
analyzing said collection history using one or more analytical techniques, said analyzing resulting in an assessment of whether said article is likely a genuine specimen of said product authorized by said source, said assessment comprising estimating a likelihood that said collection history corresponds to movement of a genuine specimen of said product; and
sending, to said mobile device, a response indicating said assessment.

2. The method of claim 1, wherein said analyzing said collection history using one or more analytical techniques comprises computing a distance between a collection location of a first of said plurality of entries of said collection history and a collection location of a second of said plurality of entries of said collection history.

3. The method of claim 1, wherein said analyzing said collection history using one or more analytical techniques comprises computing a difference between a time of collection of a first of said plurality of entries of said collection history and a time of collection of a second of said plurality of entries of said collection history.

4. The method of claim 1, wherein said analyzing said collection history using one or more analytical techniques comprises comparing said indication corresponding to the location of said mobile device at the time of said collection to geo-coordinates of an authorized location to determine whether said collection occurred at said authorized location.

5. The method of claim 1, wherein said analyzing said collection history using one or more analytical techniques comprises comparing said indication corresponding to the location of said mobile device at the time of said collection to a geo-fence outlining an authorized territory to determine whether said collection occurred within said authorized territory.

6. The method of claim 5, wherein said analyzing said collection history using one or more analytical techniques further comprises comparing a collection location of each of said plurality of entries of said collection history to said geo-fence.

7. The method of claim 5, wherein said geo-fence outlining an authorized territory comprises a metes-and-bounds description of said authorized territory.

8. The method of claim 1, wherein said reading, by said mobile device, of an identifier affixed to said article comprises scanning, using said mobile device, a barcode printed on a tag affixed to said article.

9. The method of claim 8, wherein said barcode is a Quick Response (QR) code, a 2D barcode encoded using the Data-Matrix symbology, a 2D barcode encoded using the PDF417 symbology, or a 2D barcode encoded using the Aztec symbology.

10. The method of claim 1, wherein said reading, by said mobile device, of an identifier affixed to said article utilizes a media reader to read said identifier, wherein said media reader is a barcode scanner, an imager, a camera, an RFID reader, or a Near Field Communication reader.

11. The method of claim 10, wherein said media reader is built into the said mobile device.

12. The method of claim 10, wherein said media reader is in communication with said mobile device via Bluetooth or WiFi.

13. The method of claim 1, wherein said reading, by said mobile device, of an identifier affixed to said article comprises reading, using said mobile device, an RFID tag.

14. The method of claim 1, wherein said indication corresponding to the location of said mobile device at the time of said collection comprises GPS coordinates.

15. The method of claim 1, further comprising retrieving, from a database, product data associated with said identifier, wherein said response further comprises said product data.

16. The method of claim 15, wherein said product data comprises at least one of a product name, a product description, a serial number, warranty information, and a picture of said product.

17. The method of claim 1, the method further comprising:
determining whether likelihood that said collection history corresponds to movement of a genuine specimen of said product is less than a threshold likelihood; and
where said estimated likelihood is less than said threshold likelihood, sending, to said source, an indication of a suspected counterfeit.

18. The method of claim 1, the method further comprising sending, to said source, an indication of one or more locations that said article is being offered according to said collection history.

19. The method of claim 1, the method further comprising sending, to said mobile device, at least one of a promotion, a coupon, and an advertisement for said article or a related article.

20. A computer system for providing a potential consumer of an article with an assessment of whether said article is genuine, said article purporting to be a genuine specimen of a product authorized by a source, wherein genuine specimens of said product from said source have affixed thereto an identifier unique amongst said genuine specimens, said system comprising:
at least one processor;
a network adapter in communication with said at least one processor;
a memory in communication with said at least one processor, said memory storing instructions that, when executed by said at least one processor, cause said computer system to:
receive, from a mobile device using said network adapter, a request initiated by said potential consumer, said request comprising a notification of a reading, by said mobile device, of an identifier affixed to said article and an indication corresponding to the location of said mobile device at the time of said collection;
append, to a collection history associated with said identifier, an entry comprising said indication corresponding to the location of said mobile device at the time of said collection and an indication corresponding to the time of said collection, said collection history comprising a plurality of entries, each entry corresponding to a collection of said identifier by a mobile device;
analyze said collection history using one or more analytical techniques resulting in an assessment of whether said article is likely a genuine specimen of said product authorized by said source, said assessment comprising estimating a likelihood that said collection history corresponds to movement of a genuine specimen of said product; and
send, to said mobile device using said network adapter, a response indicating said assessment.

21. The system of claim 20, wherein said memory further stores instructions that, when executed by said at least one processor, cause said computer system to:
send, to said mobile device using said network adapter, at least one or more of a promotion, a coupon, and an advertisement for said article.

22. A non-transient computer-readable storage medium storing instructions that when executed by a computer cause said computer to perform the method of claim 1.
